(19) United States
(12) Patent Application Publication
(10) Pub. No.: US 2004/0041828 A1
(43) Pub. Date: Mar. 4, 2004

(54) Adaptive non-contact computer user-interface system and method

(76) Inventor: Jon William Zellhoefer, Monterey, CA (US)

Correspondence Address: PATRICK REILLY, BOX 7218, SANTA CRUZ, CA, 95060, US

(21) Appl. No.: 10/231,834

(22) Filed: Aug. 30, 2002

(51) Int. Cl. G09G 5/00

(52) U.S. Cl. 345/706

(57) ABSTRACT

The present invention provides method and apparatus for defining and redefining a non-contact dynamic user interface, which can control multiple applications or applets with one user interface. Sensors are used to determine the position and motion of a user's body or a pre-selected object, such as a wand. As new users train the user interface, the user interface determines the functionality of newly programmed commands and directions associated with physical positions and orientations of each users body, or of a physical object that is under the user's control. Existing functions and input meanings are used if they desired. New input command meanings and functionality are added as required. In an example system, a computer is directed by hand and arm positions of the user. The speed with which the user or physical moves may also by interpreted as an input parameter by the user interface.

### FIELD OF THE INVENTION

The present invention pertains to user interfaces for multimedia entertainment and computing systems, particularly to devices and methods for controlling the various components in such systems.

### BACKGROUND OF THE INVENTION

Virtual reality has come to have many different definitions. One useful definition is that a virtual reality is presented when a user is made to experience on emotive and sensory levels that simulated objects are real objects. This virtual reality may be generated from a stored file saved in a digital electronic form in the memory of a computer. Thus, virtual reality is another way for humans to interact with a computer, for example, visually and/or by manipulating an object in the virtual space defined by the virtual reality. Many virtual reality systems allow two or more players to interact within a scenario. In many actual games, such as golf, handicapping players is allowed in order to preserve a sense of competitiveness between or among players of different skill levels and abilities and to encourage personal best performance from all players. In a broader context, many individuals suffer from disease or conditions that limit the range and/or speed of motion of the body, such as sclerosis, arthritis, or neural or muscular degenerative diseases. These limitations impede the effectiveness of prior art systems in relating positions of the user's hands and body as expressing commands, data or status values into a computer application or scenario.

Prior art vision systems can sense the position and location of physical objects or elements of a user's body or clothing and communicate these locations and positions to a computer system. Prior art computer systems can thereupon interpret the provided image data as input into a computer game or teaching scenario. Yet vision systems are often prohibitively expensive for inclusion in electronic consumer products.

Several methods currently exist that allow one to visualize, hear and/or navigate and/or manipulate objects in a virtual world or space. A virtual reality user has three typical experiences in a virtual reality world, i.e., manipulation, navigation and immersion. Manipulation may be defined as the simulated ability to reach out, contact and move objects in the virtual environment. Navigation may be defined as the ability to move within and explore the virtual world. Immersion is often about completely enclosing at least a body part of a user, so that the user perceives that he or she is residing in a virtual world.

Projected reality is an optional aspect of immersion. In projected virtual reality, the user is encouraged to perceive himself or herself projected into the scenario appearing on the screen. Projected reality can use several methods to interface between the user and the computer. For example, data gloves may be used for immersion as well as for projected reality. When the user wears the data glove, the user's hand movements are communicated to the computer so that the user may, for example, move his/her hand into the graphic representation of a virtual object and manipulate it.

Unfortunately, data gloves suffer from several disadvantages. First, there is often a delay between the user moving the data glove and then seeing the user's virtual hand movement on the display. Secondly, to use the gloves successfully, electromechanical sensors on the data gloves often require constant recalibration. Third, affordable data gloves that accurately translate the user's hand movements into virtual hand movements in the virtual space are not currently available. Finally, data gloves and HMDs may be bothersome for a user to wear and to use.

A mouse is another interface that has been used to interact with a three-dimensional (3-D) display. Clicking on the mouse controls icons or graphical user interfaces that then control the movement of a virtual object. The user uses a mouse to click on a graphical user interface to move the virtual object and the virtual plane toward the user and/or away from the user. If the user wants to move virtual object and virtual plane up or down, then the user clicks on and moves graphical user interface accordingly. The user clicks onto graphical user interface to rotate the virtual object and the virtual plane. The user has difficulty with simultaneously translating and rotating object. Moreover, it is difficult for the user to translate the movements of the mouse to control graphical user interfaces. Thus, there is no direct linear correlation between the user's supplied information via the mouse and the resulting motion on the graphical user interfaces, and the ultimate movement of virtual objects and virtual planes.

The user has difficulty with simultaneously rotating and moving objects up or down, or towards or away from the user. Thus, the user has difficulty with fully controlling any particular virtual object using the currently available input/output devices. Furthermore the user has difficulty with simultaneously combining more than two of the possible six degrees of freedom.

Three translations and three rotations are the six different degrees of freedom in which an object may move. An object may move forward or backward (X-axis), up or down (Y-axis) and left or right (Z-axis). These three movements are collectively known as translations. In addition, objects may rotate about any of these principle axes. These three rotations are called roll (rotation about the X-axis), yaw (rotation about the Y-axis) and pitch (rotation about the Z-axis).

Currently, a keyboard or a mouse are the most commonly available input devices that interact with certain 3-D virtual applications, such as three-dimensional Web browsers. The keyboard and mouse usually allow only horizontal and vertical movements. A keyboard and a mouse do not allow a user to navigate through a three-dimensional virtual space utilizing the six degrees of freedom. In addition, a keyboard and a mouse do not allow accurate manipulation of a virtual object. Thus, no consumer market priced input/output device presently exists for accurately interpreting a user's body positions and movements within freedoms of movement and into a 3-D virtual reality application.

Therefore, it is desirable to have an affordable non-invasive interface between a user and a virtual space that allows the user to manipulate virtual objects, drive a computer-based game or training scenario, or to navigate through the virtual space with six degrees of freedom in a sequential or nonsequential manner.

### OBJECTS OF THE INVENTION

It is an object of the present invention to provide a technique that enables a user to communicate commands to a computer system by means of movement of part or all of the user's body and/or spatial manipulation of a physical object.

It is a further optional object of the present invention to provide a computer input apparatus that enables a computer system to be personalized for one or more users.

### SUMMARY OF THE INVENTION

The foregoing and other objects, features and advantages will be apparent from the following description of the preferred embodiment of the invention as illustrated in the accompanying drawings. The method of the present invention enables a user to communicate commands and optionally data to an information technology system, such as a personal computer system, by means of (1) independent movement of part or all the user's body, or (2) movement of a physical object, or (3) a combination of part or all of the user's body and a physical object.

In a first preferred embodiment a set of sensors are arranged about a three-dimensional input zone. The user inserts his or her hand into the zone in order to communicate with a computer system. The sensors monitor one or more parameters related to the shape of the hand and transmit measurements of the parameter(s) to the computer system. The user may personalize the present invention's provision of input to the computer system in relation to his or her hand's shape, range of motion, speed of motion, and other suitable measurable characteristics of a hand. The user may optionally further personalize the information technology system by teaching the information technology system associations between the hand's instantaneous shape, motion, or other suitable and time variable characteristics of the hand. A computer system, or the information technology system, may be trained to compensate for slowing changing parameters of the hand, such as expanding the acceptable range of a measurement of a learned shape or motion of the hand when the user is undergoing a gain or loss of mass, or a gradually occurring increase or decrease in range of motion, over several days or weeks. Sensors may detect an isolated characteristic of the hand or a cumulative parameter. The isolated characteristic might be the location of the tip of the ring finger within the input zone, or the speed of motion of the hand from a first position to a second position. One example of a cumulative parameter might be the degree of shade imposed by the hand, and in relation to a light source, on a surface of, or sensed by, the sensor by the hand. Sensors measuring cumulative parameters are not designed to image the hand but rather to monitor a variable parameter that consistently and predictably varies as the hand assumes pre-identified states or shapes, e.g., a closed first or a hand-shake position. As one example, measuring the degree of shade imposed on three separate surfaces by the hand when placed in a closed fist shape will cause suitable sensors to generate a set of values that can be associated with the instantiation of the closed fist by the computer system.

In certain alternate preferred embodiments of the present invention the user may teach the computer system meanings that are to be associated with individual positions or motions of the hand. The user may define ranges of positional and motion parameters that will be associated by the computer system with commands, data and/or status values by the computer system. As one example, the present invention may be teach the computer system that a first position of the hand represents a maximum value of a pre-identified parameter within a computer game scenario, that a second position represents a minimum value of a the same pre-identified parameter, and that positions assumed by the hand as the hand transitions between the first and the second position represent values located on a continuum of magnitude of the pre-identified parameter. For example, the first position might be an open hand. The second position might be a closed fist. The pre-identified parameter of the computer game system might be the simulated speed of a car icon in an auto racing game scenario. As the hand is closed into a fist, and measured within the input zone, or the speed of motion of the hand from a first position to a second position. One example of a cumulative parameter might be the degree of shade imposed by the hand, and in relation to a light source, on a surface of, or sensed by, the sensor by the hand. Sensors measuring cumulative parameters are not designed to image the hand but rather to monitor a variable parameter that consistently and predictably varies as the hand assumes pre-identified states or shapes, e.g., a closed first or a hand-shake position. As one example, measuring the degree of shade imposed on three separate surfaces by the hand when placed in a closed fist shape will cause suitable sensors to generate a set of values that can be associated with the instantiation of the closed fist by the computer system.

In certain alternate preferred embodiments of the present invention the user may teach the computer system meanings that are to be associated with individual positions or motions of the hand. The user may define ranges of positional and motion parameters that will be associated by the computer system with commands, data and/or status values by the computer system. As one example, the present invention may be teach the computer system that a first position of the hand represents a maximum value of a pre-identified parameter within a computer game scenario, that a second position represents a minimum value of a the same pre-identified parameter, and that positions assumed by the hand as the hand transitions between the first and the second position represent values located on a continuum of magnitude of the pre-identified parameter. For example, the first position might be an open hand. The second position might be a closed fist. The pre-identified parameter of the computer game system might be the simulated speed of a car icon in an auto racing game scenario. As the hand is closed into a fist, and measured values related to the instantaneous position of the hand are reported by the present invention to the computer system, the computer system may associate higher speeds of the car with hand positions that are more closed.

In certain alternate preferred embodiments of the present invention a computer system encourages the user to improve the user's performance, and/or accuracy, and/or range of motion and/or speed of motion. Certain of these preferred embodiments may be used in medical or therapeutic settings, wherein the user scores higher in testing or gaming by expanding the performance range of his or her hand, body part or entire body.

Alternatively or additionally, the user may score higher in test, games or simulations by increased performance in tasks of sports, military, police, or occupational scenarios, e.g., in swinging a golf club or pointing a physical object. In certain still alternate preferred embodiments of the present invention a physical object, e.g., a golf club or a squash racket, may be sensed by the sensors for interpretation as commands, data and/or status values by the computer system. The sets of sensors may be or comprise electromagnetic sensors, photonic sensors, motion sensors, audio sensors, heat sensors, and/or sonic sensors.

Certain preferred embodiments of the present invention monitor or sense a position of an object or and an operator body element, e.g., a body part or a body limb, over a time period and compensate for jitter or shaking of the monitored or sensed object or body element to derive an intended, central or averaged position, shape or configuration of the object or body element. The preferred embodiment may therefrom associate the derived position, shape or configuration of the object or body element with a position, shape or configuration of the object or body element that is interpreted as providing information or instructions to the present invention or via the present invention to other systems.

### BRIEF DESCRIPTION OF THE DRAWINGS

The present invention is illustrated by way of example and not a limitation in the figures of the accompanying drawings in which like references indicate similar elements.

FIG. 1 illustrates the effect of an object upon the reception of energy transmitted from a point source.

FIG. 2 presents the relative effect of an object upon transmission of energy to a sensor as the hand is placed closer or farther from the point energy source.

FIG. 3 shows the changes in an imposed shadow as the shape and location of the hand of FIG. 2 is altered.

FIG. 4 illustrates a preferred embodiment of the present invention, or invented cube having an object placed with the invented cube.

FIG. 5 shows the shadows cast by the object of FIG. 4 FIG. 6 presents a derivation of a set of measured values relating to the size of the shadows of FIG. 5.

FIG. 7 illustrates a derivation of sets of measured values as varied by movement of the object of FIG. 4.

FIG. 8 illustrates a derivation of alternate sets of measured values as varied by changing the shape of the object of FIG. 4.

FIG. 9 is a schematic diagram of the invented cube of FIG. 4.

FIG. 10 presents a sphere located within the invented cube of FIG. 4.

FIGS. 11A and 11B illustrate a first preferred embodiment having an input zone for surrounding a field of play. FIG. 12 is a top view of the control zone of FIG. 11 showing a range of motion of the user's hand.

FIG. 13 illustrates using the control zone of FIG. 11 applied to teach a computer system to compensate for an arthritic hand's range of motion in interpreting positions and speed of the arthritic hand as commands, data and/or status values.

FIG. 14 illustrates the use of sensors of the control zone that measure the degree of shade the hand imposes upon three separate surfaces.

FIG. 15 is a flowchart of the teaching mode of the control zone of the present invention of FIG. 11.

FIG. 16 is a flowchart of the input mode of the play zone of the present invention of FIG. 11.

FIG. 17 illustrates a second preferred embodiment of the present invention wherein a squash racket is used to input commands and data to a computer system.

FIG. 18 illustrates a third preferred embodiment of the present invention wherein the user's body position is used to input commands and data to a computer system.

FIG. 19 is a flowchart of an optional implementation of the play zone of FIG. 1 wherein the present invention is used as a therapeutic tool.

FIG. 20 is a flowchart of an optional implementation of the play zone of FIG. 11 wherein the present invention is used as a sports performance-training tool.

### DETAILED DESCRIPTION OF THE PREFERRED EMBODIMENTS

In describing the preferred embodiments, certain terminology is utilized for the sake of clarity. Such terminology is intended to encompass the recited embodiment, as well as all technical equivalents which operate in a similar manner for a similar purpose to achieve a similar result. Reference is made in the following detailed description of the preferred embodiment to the drawings accompanying this disclosure. These drawings illustrate specific embodiments in which the invention may be practiced. It is to be understood that other embodiments may be utilized and structural changes may be made by one skilled in the art and in light of this disclosure and without departing from the scope of the claims of the present invention.

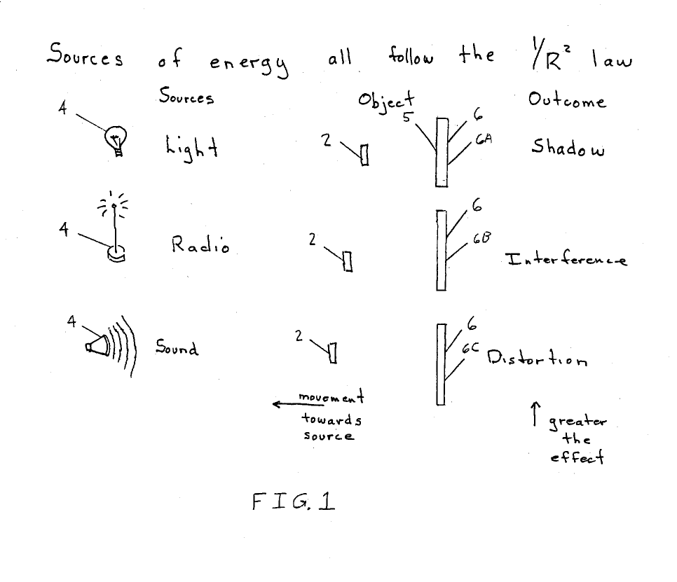

Referring now generally to the Figures and particularly to FIG. 1, the effects of a physical object 2 upon the receipt of signals or energy from a source 4 or an emitter 4 of radiation or sound energy can be measurable and repeatable. As one example, objects 2, to include human body elements, can distort or effect energy transmissions as received by a sensor 6. In particular, objects 2 cast shadows 5 upon planar light sensors 6A, interfere with radio signals as received by radio wave sensors 6B and distort sound energy as received by sound sensors 6C. Where the emitting energy is known, and the relationships among the energy source 4 or emitter 4, the sensors 6 and the object 2 are understood, the effect of the position and shape of the object 2 upon the sensors 6 can be used to interpret the position, configuration or shape of the object 2 as providing informational content to the sensors or an information technology system that is in communication with the sensors 6.

In various alternate preferred embodiments of the present invention the sensors 6 may be or comprise an electromagnetic sensor, a photonic sensor, a motion sensor, an audio sensor, a heat sensor, a sonic sensor, and/or another suitable sensor known in the art. The emitters 4 or energy sources 4 may be matched to the sensors 6 and may be comprise an electromagnetic emitter, a photonic emitter, a vibration emitter, an audio emitter, a heat emitter, a sonic emitter, and/or another suitable emitter known in the art.

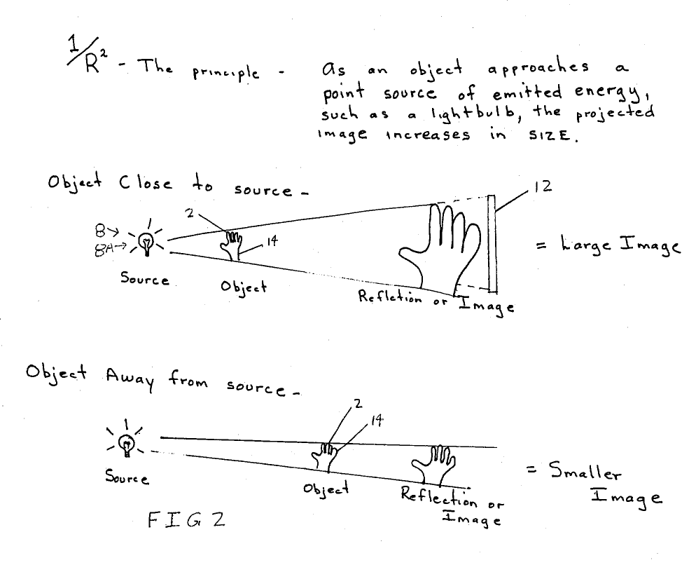

Referring now generally to the Figures and particularly to FIG. 2, it is noted that as the object 2 is located closer to a point source of energy 8, e.g. a light bulb 8A, a radio wave transmitter, or a sound signal, the energy distorting or absorbing effect of the object 2 is increased. For example, a shadow 10 cast upon a planar light sensor 12 by a hand 14, where the hand 14 is placed in between the light bulb 8A and the planar light sensor 6A is increased as the hand 14 is placed and closer to the light bulb 8A. The physics of this distortion effect upon energy received by the sensor 6 is often dependent upon an inverse square relationship wherein the energy received by a point in space is inversely proportional to the square of the distance between the point in space and the origin of the emitted energy. By this effect, the degree, nature or amount of distortion imposed upon a sensor 6 by an object can be inversely proportional to the square of the distance between the object 2 and the energy source 4.

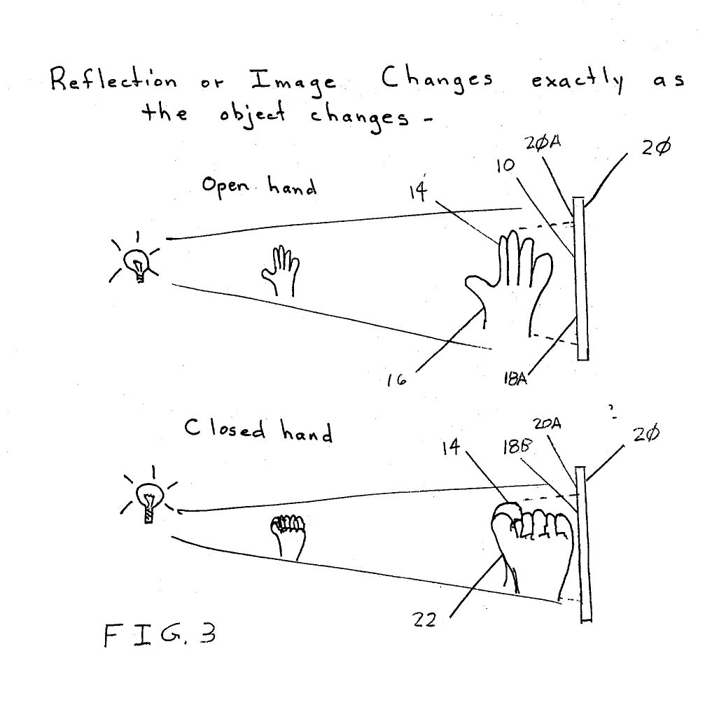

Referring now generally to the Figures and particularly to FIG. 3, the distortion, shadow 10, reflection or image imposed upon the sensor 6 by the object 2 can change as the location, instantaneous shape and instantaneous configuration of the object 2 or a body element, e.g. the hand 14, change. An open hand 16 may cause a shadow 18A of a certain size upon a point or non-point sensor 20 having a sensing surface area 20A, such as the planar sensor 20, whereas a closed hand 22 may cause a shadow 18B or other energy transmission pattern distortion of a second size upon the sensing surface area 20A. The intensity of the shadow 18A (or other energy transmission pattern distortion) may also be measured by the sensor 6, 20 and interpreted by the method of the present invention as having informational content regarding the position of the hand 14 or object 2.

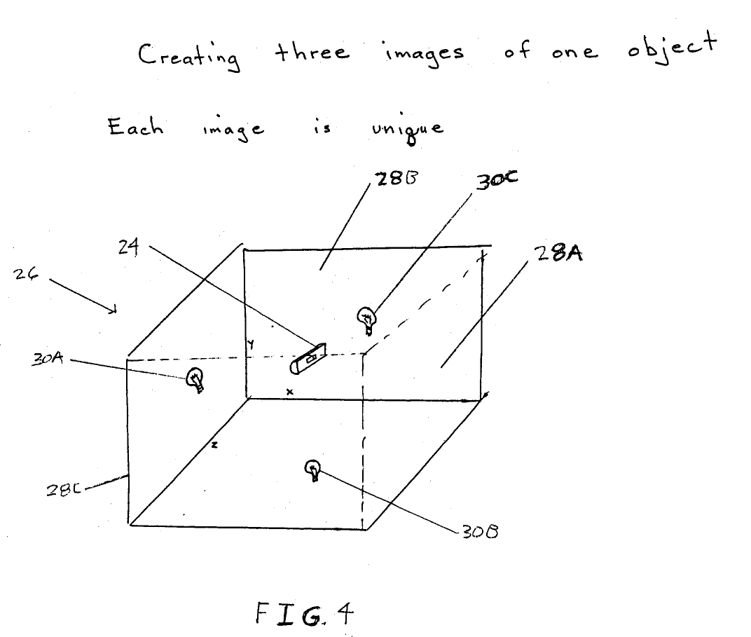

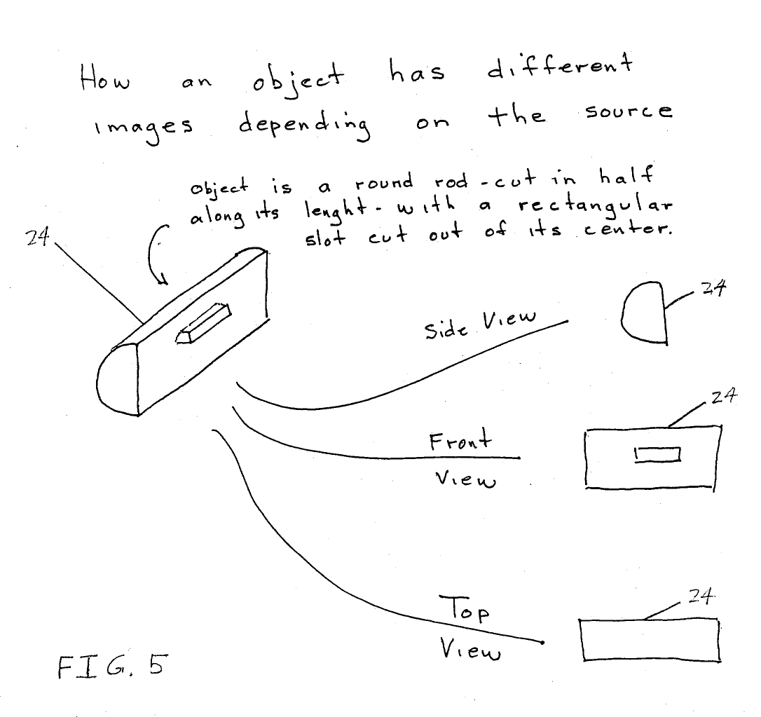

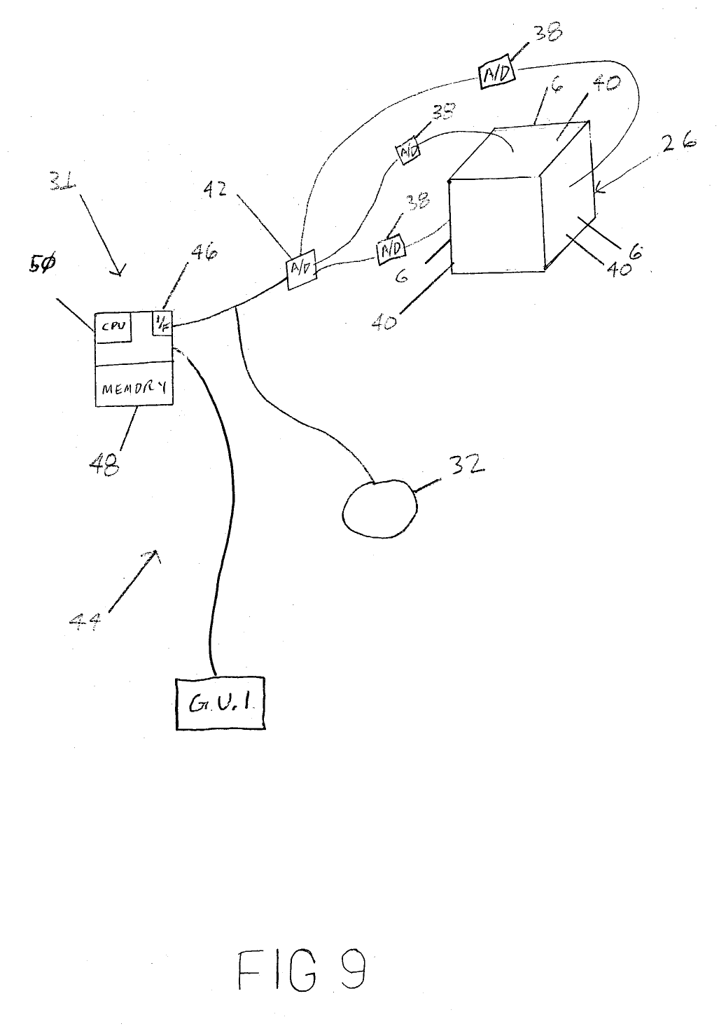

Referring now generally to the Figures and particularly to FIGS. 4 and 5, a first object 24 is placed within a cubic embodiment of the present invention, or invented cube 26. The invented cube 26 comprises three individual sensors sensing surfaces 28A, 28B & 28C having sensing surfaces and three energy emitters 30A, 30B & 30C. The position of the first object 24 causes an energy distortion, e.g., a shadow 5 if the energy transmitters 30A, 30B & 30C are light emitters, upon the individual sensors sensing surfaces 28A, 28B & 28C, or sensing surfaces 28A, 28B & 28C. The degree of distortion on all three sensing surfaces 28A, 28B & 28C is measurable as three separate parameters generated by the sensing surfaces 28A, 28B & 28C. The three parameters may then be matched by a computer system 31, as shown in FIG. 9, to associate the three values as a meaningful input, instructions or data to the computer system 31 or a networked computing system 32. For example, placing the first object 24 in a certain position within the invented cube 26 may inform a computer game system 31 that a game player instructs the game system 31 to initiate or start a game program. The invented cube 26 is superior to prior art in that the computer system 31 or networked computing system 32 of FIG. 9 is directed by moving the first object 24 and without the invented cube 26 detecting or imaging or transferring the image of the exact shape of the first object 24 to the computer system 31 or networked computing system 32.

Referring now generally to the Figures and particularly to FIG. 6, a set of individual images 34, or total but separate effects, of the first object 24 upon each of the sensing surfaces 28A, 28B & 28C is measured and quantified as single parameters. The unique set of three values is associated by the invented cube 26 with a unique position and orientation of the object 24 within the invented cube 26.

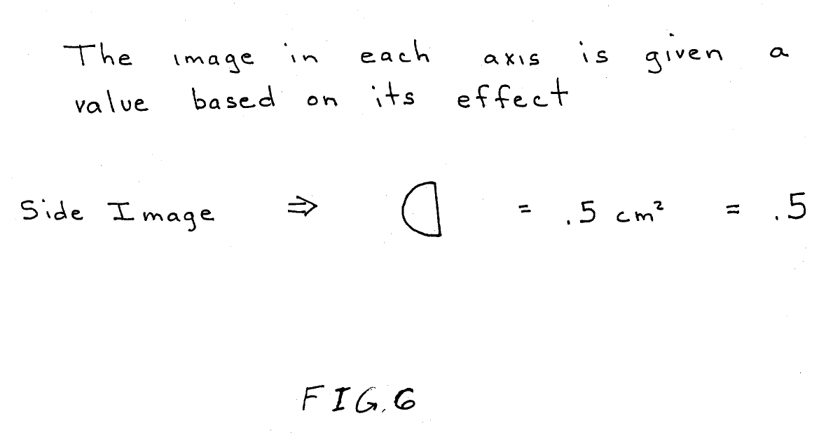

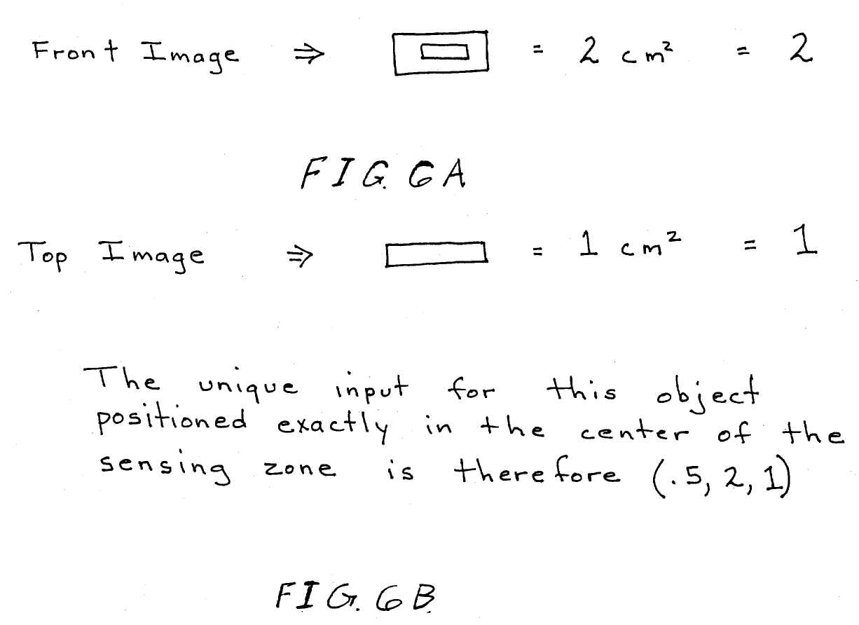

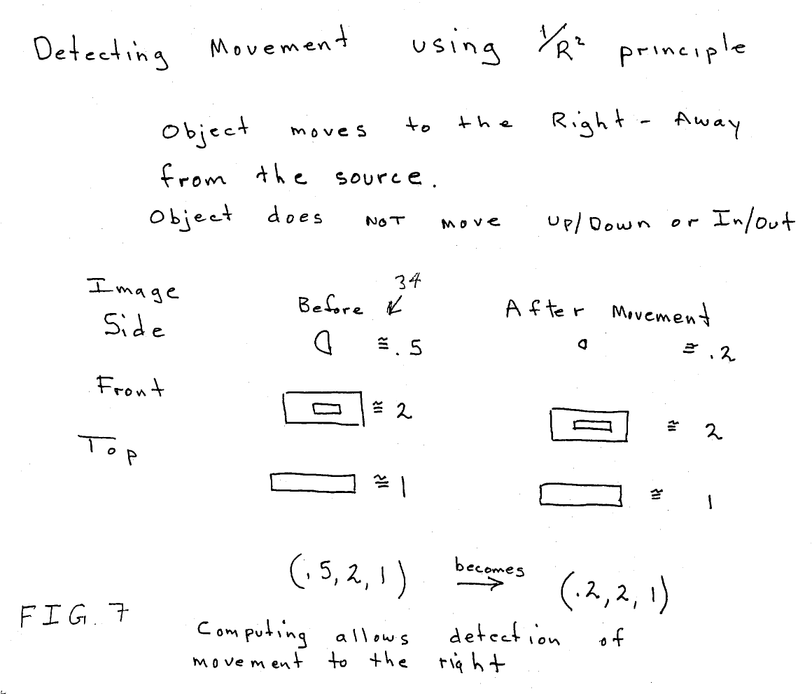

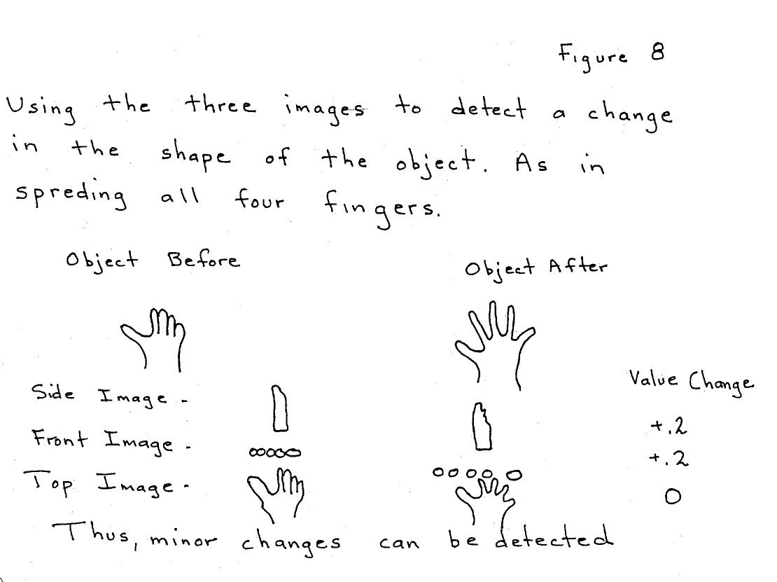

Referring now generally to the Figures and particularly to FIGS. 7 and 8, the invented cube 26 detects motion and rates of motion of a hand 14 placed within the invented cube 26 by monitoring the changing values of the outputs of the sensors 6. Additionally, the invented cube 26 tracks changes in the shape or configuration the hand 14 by monitoring the values of the outputs of the sensors 6 as a set of individual images 36A & 36B, or total but separate effects, of the first object 24 upon each of the sensing surfaces 28A, 28B & 28C

Referring now generally to the Figures and particularly to FIG. 9, the invented cube 26 comprises analog to digital converters 38, or A/D converters 38, each A/D converter 38 coupled with a sensor 6 having a sensing surface 40. (Note that the FIG. 9 shows a redundancy of A/D converters 38 & 40 for the sake of illustration; a preferred embodiment of the invented cube 26 would have either one universal A/D converter 42 or a set of A/D converters 38.) The A/D converters 38 receive analog inputs from the sensing surfaces 40, where the analog inputs are measures of, or related to, the quantities or pattern(s) of energy received by sensing surfaces 40. The A/D converters 38, or alternately a unified A/D converter 42, convert a received analog signal from a sensing surface 40 and converts the analog signal into a digital value. The A/D converters 38 or the unified A/D converter 42 then communicate the digital values to a data processing or information technology system 44, or IT system 44, that may be or comprise the computer 31 and/or the networked computing system 32. The IT system 44 has an interface 46 to the A/D converter(s), a memory 48 and a central processor 50. The central processor 50, or processor 50, or CPU 50, associates two or more digital values received from the A/D converters 38 or the unified A/D converter 42 as sets of values. Each set of measured values is then compared for matches with sets of values stored within the memory 48. The CPU 50 selects the closest match, or a set of close matches between stored values, as found by comparing a particular set of measured values with the stored sets of values. Alternatively or additionally, the invented cube 26 may generate sets of values by mathematically modeling the first object 24 or a body element, e.g., the hand 14, and comparing the set of measured values with sets of values generated by the modeling computation. The CPU 50 then associates the set of measured values with an informational content, where the informational content is selected or indicated by a relatedness between the informational content and one or more stored or generated sets of measured values. The CPU 50 then informs the IT system 44 of the informational content, e.g., turn a virtual switch on. The IT system 44 may be or comprise a personal computer, a networked communications network, or other suitable information technology system known in the art.

The memory 48 may be or comprise a memory coupled with the CPU via a computer network, and may be or comprise a hard disk, a CD disk, a DVD, a random access memory, a read only memory, a programmable memory, a reprogrammable memory, and/nother suitable memory known in the art, in combination, in distributed combination, or as a unified memory. The memory 48 may hold or employ, or empower the IT system 44 to employ, an applications program. The applications program may enable the IT system 44 to interpret sensor inputs as providing informational content about the speed of motion of the hand 14 or object 24 sensed by the sensors 6. Alternatively or additionally, the applications program may correlate assigned meanings, or assign meanings to, signals sent from the sensors 6 and to the IT system 44. These meanings may, for example, be or be associated with language content, medical data, therapeutic data, computer game data, or other suitable meanings, values and scenarios known in the art.

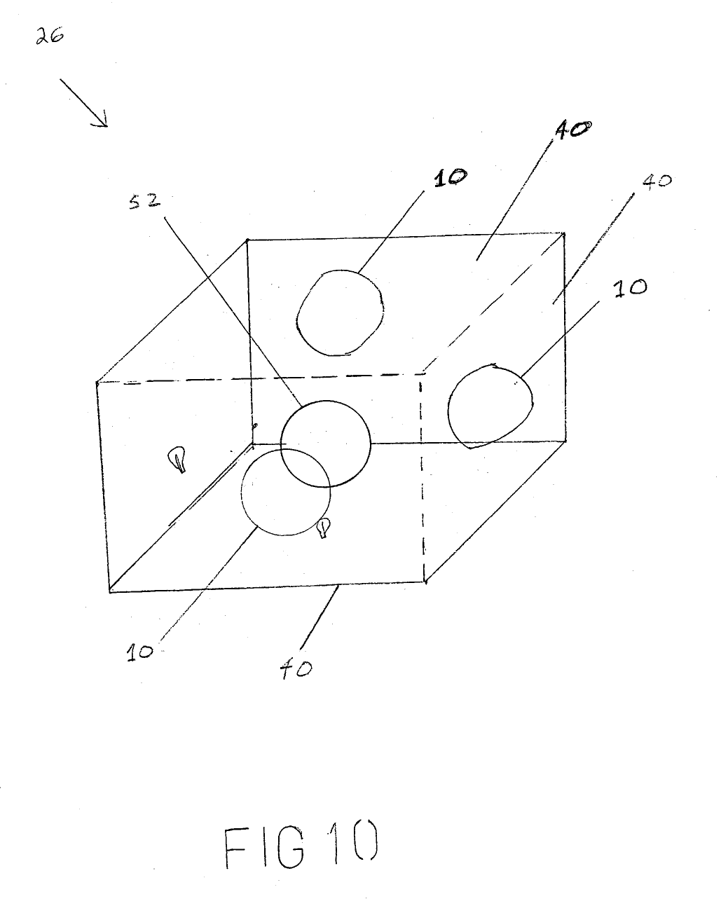

Referring now generally to the Figures and particularly to FIG. 10, a sphere 52 imposes shadows 10 upon three mutually orthogonal sensing planes 40. The amount of light area received by each of the three sensing planes 40 is separately measured and communicated to the IT system 44. A set of measurements generated substantially simultaneously by the sensing planes 40 can be interpreted by the IT system 44 is indicating that the sphere 52 is located at an approximate position within the invented cube 26. The sphere 52 example is offered to illustrate that the state of all three shadows 10 imposed on the sensors 6 can be uniquely associated with a unique position of the sphere 52 within the invented cube 26.

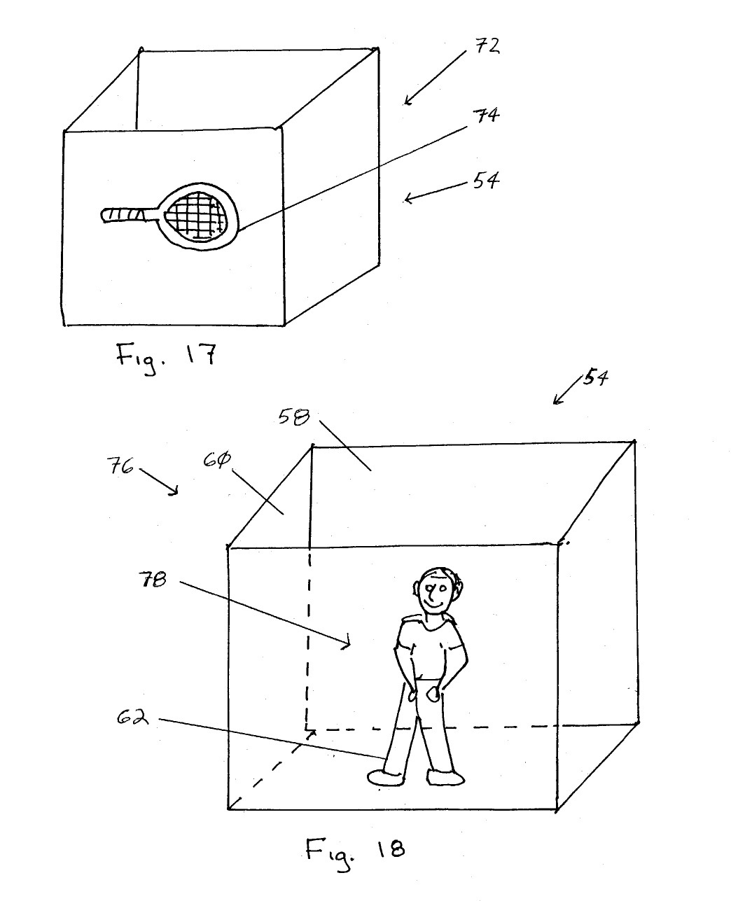

Referring now generally to the Figures and particularly to FIGS. 11A, 11B and 18, a second preferred embodiment 54, or second system 54, has a control zone 56, having a free movement zone 58, or free zone 58, for surrounding a field of play 60. The field of play 60 of the free zone 58 is three dimensional and provides a free zone 58 large enough to accept and envelope a human player 62. The sensors 40 monitor the effect of the hands 14 instantaneous position on three separate areas or planes 28A, 28B & 28C.

Referring now generally to the Figures and particularly to FIG. 12, the second system 54 monitors the user's hand 14 across a range of motion 64 within the control zone 56. The IT system 44 determines how fast the hand 14 is moving by comparing sensor signals at two or more times.

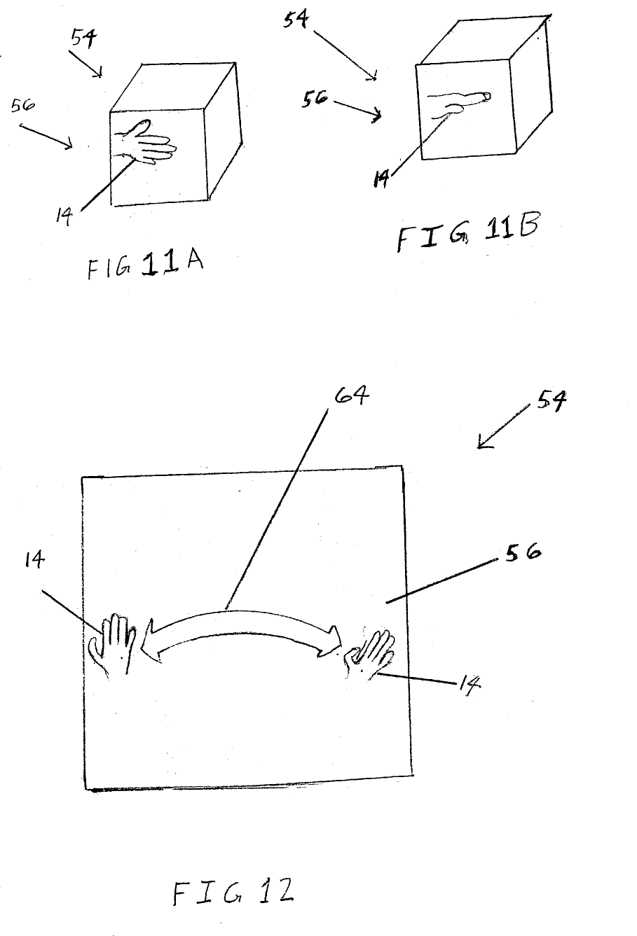

Referring now generally to the Figures and particularly to FIG. 13. The second system 54 having the play zone 56 is applied to teach the IT system 44 to compensate for an arthritic hand's 66 range of motion 67 in interpreting positions and speed of the arthritic hand 14 as commands, data and/or status values. The IT system 44 may be calibrated and personalized to associate the positions and locations of a unique users hands 66 with a range of values or meanings of the applications program. By this method an arthritic game player may be enabled to play against a more nimble opponent by either interpreting the nimble player's hand 14 motions in a “handicapped” system, e.g., golf handicapping, or by providing a value multiplier or additive to the arthritic person's movements and/or hand 14 positions. In various alternate preferred embodiments, alternatively or additionally the motions of other objects 2 and/or body parts as moved or manipulated by a player may be handicapped or increased in relative value within a computer applications program scenario. The method of the present invention may be employed to enhance the computer usage of persons with disabilities other than arthritis, e.g., palsey, amputations, carpal tunnel, or repetitive stress injuries.

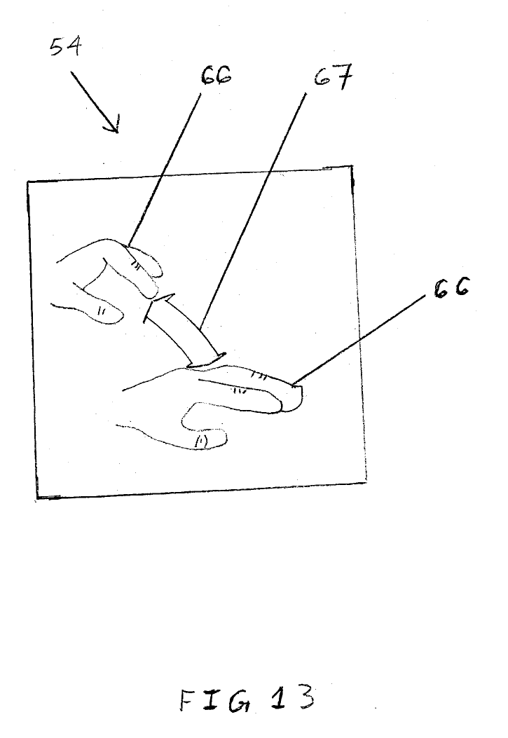

Referring now generally to the Figures and particularly to FIG. 14, the use of the sensors 6 of the control zone 56 measures the degree of shade or shadow 68 the hand 14 imposes upon three separate surface sensors 70.

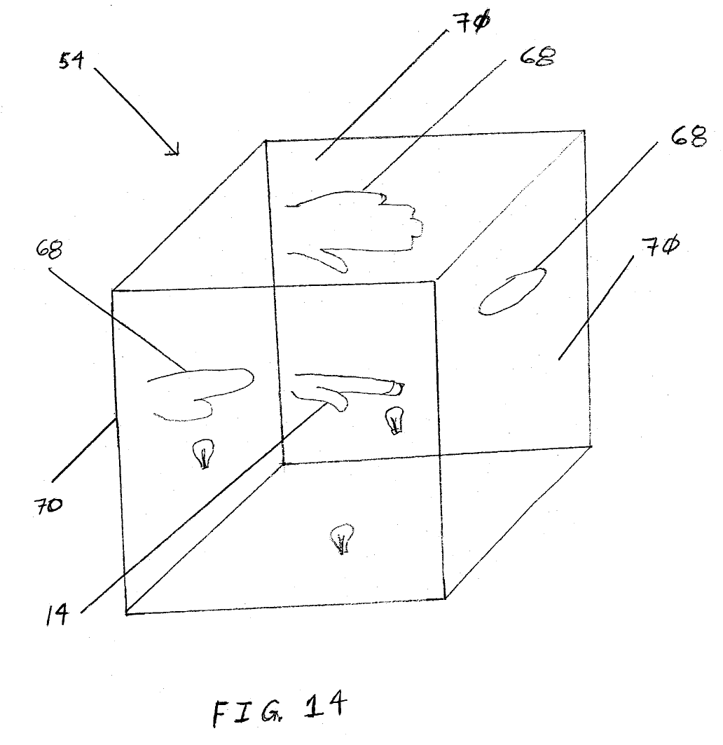

Referring now generally to the Figures and particularly to FIG. 15, FIG. 15 is a flowchart of the teaching mode of the second system 54.

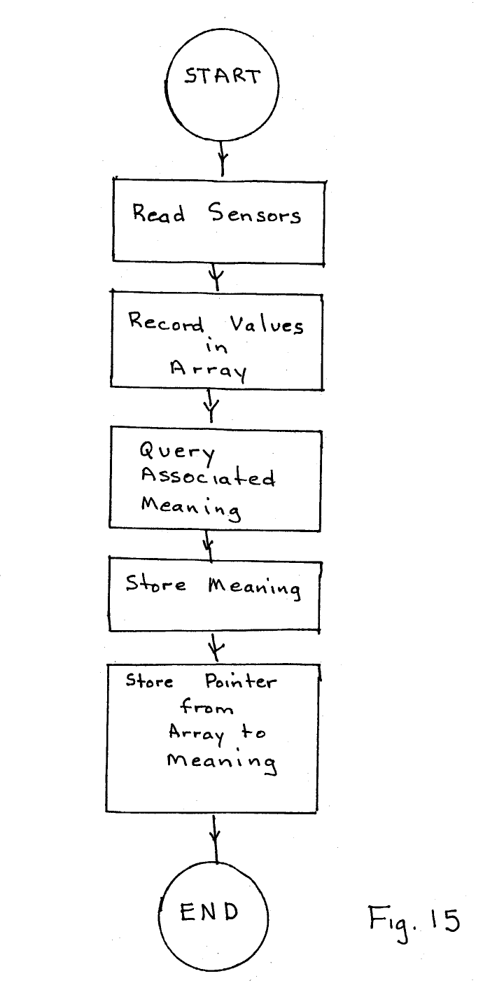

Referring now generally to the Figures and particularly to FIG. 16, FIG. 16 is a flowchart of the input mode of the second system 54.

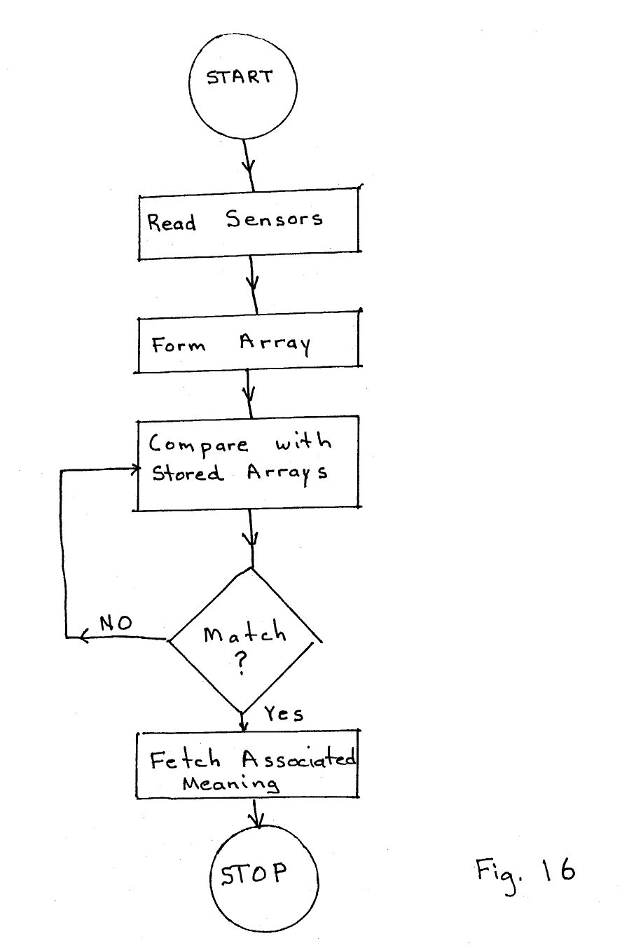

Referring now generally to the Figures and particularly to FIG. 17, an enhanced third preferred embodiment of the present invention 72, or third system 72, comprises a squash racket 74, wherein the squash racket 74 is used to input commands and data the IT system 44. In various alternate preferred embodiments, alternatively or additionally the motions of other objects 2 and/or body parts as moved or manipulated by a player may be within suitable alternate computer applications program scenarios, to include such objects as a hockey stick, a golf club, a foot, or a glove.

Referring now generally to the Figures and particularly to FIG. 18, an enhanced fourth preferred embodiment of the present invention 76, or fourth system 76, enables the user's body position 78 to be interpreted as input commands and data to the IT system 44. In various alternate preferred embodiments, alternatively or additionally the motions of other objects and/or body parts as moved or manipulated by a player may be interpreted within suitable alternate computer applications program scenarios, such as ice hockey, golf, dance, or a martial art.

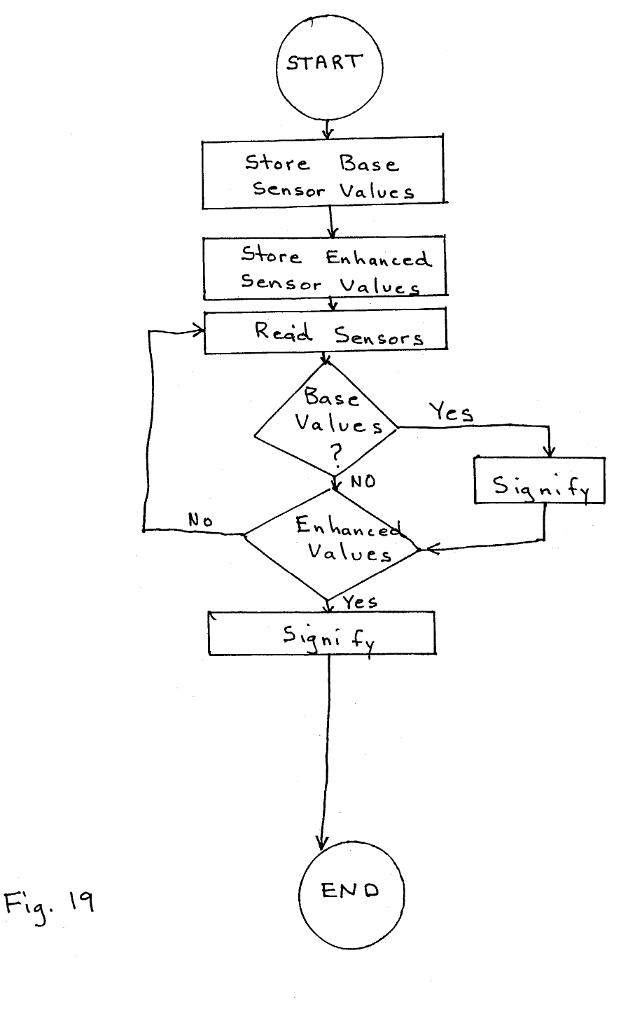

Referring now generally to the Figures and particularly to FIG. 19, FIG. 19 is a flowchart of an optional implementation of the control zone of FIG. 11 wherein the present invention is used as a therapeutic tool.

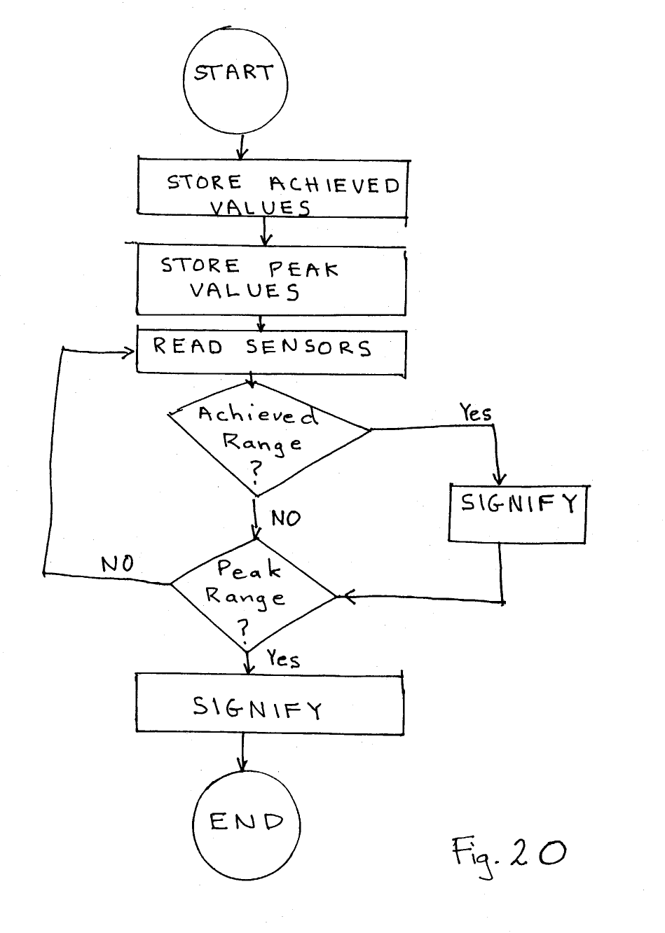

Referring now generally to the Figures and particularly to FIG. 20, FIG. 20 is a flowchart of an optional implementation of the control zone of FIG. 11 wherein the control zone is used as a sports performance-training tool.

Those skilled in the art will appreciate that various adaptations and modifications of the just-described preferred embodiments can be configured without departing from the scope and spirit of the invention. Other suitable sensory input computer interfacing equipment, techniques and methods known in the art can be applied in numerous specific modalities by one skilled in the art and in light of the description of the present invention described herein. Therefore, it is to be understood that the invention may be practiced other than as specifically described herein. The above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

What is claimed is:

1. A method of defining a user interface in a computer system in response to the state of a physical object, comprising:
providing a computer system, the computer system having a computer and input sensors, the input sensors coupled with the computer and the sensors for sensing a state of the physical object;
placing the physical object into a first state;
employing the input sensors to sense the first state, and communicating a sensors output to the computer;
storing the sensors output in the computer;
associating the first state with an assigned meaning; and
programming the computer to associate the sensors output with the assigned meaning;
placing the physical object into a second state; and and returning the physical object into the first state, whereby the input sensors inform the computer system of the occurrence of the first state, whereby the assigned meaning is provided as an input, such as a command or a data value, to the computer system.

2. The method of claim 1, wherein the physical object comprises a part of the user's body.

3. The method of claim 1, wherein the physical object comprises at least part of the user's hand.

4. The method of claim 1, wherein the first state of the physical object is produced by an associated state of the user's body.

5. The method of claim 1, wherein the method further comprises the steps of:
defining a graphical user interface, or GUI, for controlling the functionality of a first application;
controlling the first application with the defined GUI, programming the computer to associate the assigned meaning of the first state with an input of the GUI; and
redefining the graphical user interface for controlling the functionality of at least one other application, wherein redefining further comprises programming the computer to associate the input of the defined GUI with an input of at least one other application, whereby the first state is recognized as a command or data value by the computer in when executing the first application or the at least one other application.

6. A computer system comprising:
a sensor for sensing the position of a physical object and generating a sensor output indicating a sensing of the position;
a processor, responsive to the sensor output, and for executing an application program, the processor including:
an input module, responsive to at least one sensor output, wherein the input module accepts the sensor output corresponding to the position of the physical object; and
an interpreter, the interpreter associating the at least one sensor output with an input to the application program, whereby the input may be a command or a data value.

7. The computer system of claim 6, wherein the physical object comprises a part of the user's body.

8. The method of claim 6, wherein the physical object comprises at least part of the user's hand.

9. The method of claim 6, wherein the first state of the physical object is produced by an associated state of the user's body.

10. The computer system of claim 6, wherein the input interpreter associates an input to the application in relation to a comparison of the sensor output and a second sense output.

11. The computer system of claim 10, wherein the comparison is a measure of speed of movement of the physical object.

12. The computer system of claim 6, wherein the application program is a computer game.

13. The computer system of claim 6, wherein the application program is a multi-user computer game.

14. The computer system of claim 6, wherein the application program is a medical diagnostic program.

15. The computer system of claim 6, wherein the application program is a human language translator.

16. The computer system of claim 6, wherein the sensor is a proximity sensor.

17. The computer system of claim 6, wherein the sensor is selected from the group consisting of an electromagnetic sensor, a photonic sensor, a motion sensor, an audio sensor, a heat sensor, and a sonic sensor.
